(19) United States
(12) Patent Application Publication
(10) Pub. No.: US 2021/0232656 A1
(43) Pub. Date: Jul. 29, 2021

(54) CALCULATION APPARATUS, CALCULATION METHOD AND PROGRAM

(71) Applicant: NIPPON TELEGRAPH AND TELEPHONE CORPORATION, Tokyo (JP)

(72) Inventors: Naoki MARUMO, Tokyo (JP); Tomoharu IWATA, Tokyo (JP)

(73) Assignee: NIPPON TELEGRAPH AND TELEPHONE CORPORATION, Tokyo (JP)

(21) Appl. No.: 17/050,760

(22) PCT Filed: Apr. 1, 2019
(86) PCT No.: PCT/JP2019/014460

§ 371 Date: Oct. 26, 2020

(30) Foreign Application Priority Data
Apr. 27, 2018 (JP) 2018-087056

(51) Int. Cl. G06F 17/11; G06F 17/17

(52) U.S. Cl. CPC G06F 17/11; G06F 17/17

(57) ABSTRACT

Disclosed is a method whereby a solution of an optimization problem under multiple structures can be obtained at high speed even when a function to be minimized is ill-conditioned. One aspect of the present invention relates to a computing device that computes an optimal solution of an optimization function f+g+h represented by a sum of three functions f, g, and h, including: a first computing unit that computes a proximal point of a function F+h representing the optimization function f+g+h, the function F+h being a sum of a function F=f+g represented by a sum of two functions f and g and a function h; a second computing unit that computes an approximate proximal point of the function F; and a convergence determination unit that determines whether or not a predetermined termination condition is satisfied based on a proximal point computed by the first computing unit and an approximate proximal point computed by the second computing unit, and causing the first computing unit and the second computing unit to repeatedly compute the proximal point and the approximate proximal point until the predetermined termination condition is satisfied.

### TECHNICAL FIELD

The present invention relates to a technique for solving an optimization problem.

### BACKGROUND ART

Commonly, an optimization problem involves computation to find a solution that minimizes the value of a function. When there are solutions and it is desired to find one that has a good structure, terms that impose constraints or regularization on the function to be minimized are added, and the solution that minimizes the sum of the two terms is computed. For example, ridge regression and sparse logistic regression, which are often used in statistics, solve an optimization problem of the sum of two terms. The Douglas-Rachford method is known as a method of computing a solution that minimizes the sum of two terms (NPL 1).

When there are two structures postulated in a solution, a minimization problem minimizing the sum of three terms is solved. Such optimization problems under multiple structures arise in support-vector machines, compressed sensing, estimation of sparse covariance matrices, and so on. Several methods have been proposed for solving optimization problems under multiple structures (NPL 2 to 4).

### CITATION LIST

### Non Patent Literature

[NPL 1] Damek Davis and Wotao Yin. Faster convergence rates of relaxed Peaceman-Rachford and ADMM under regularity assumptions. Mathematics of Operations Research, 2017.
[NPL 2] Radu loan Bot and Erno Robert Csetnek. On the convergence rate of a forward-backward type primal-dual splitting algorithm for convex optimization problems. Optimization, 64(1):5-23, 2015.
[NPL 3] Laurent Condat. A primal-dual splitting method for convex optimization involving Lipschitzian, proximable and linear composite terms. Journal of Optimization Theory and Applications, 158(2):460-479, 2013.
[NPL 4] Damek Davis and Wotao Yin. A three-operator splitting scheme and its optimization applications. Set-Valued and Variational Analysis, pages 1-30, 2015.

### SUMMARY OF THE INVENTION

### Technical Problem

The method of NPL 1 is a method of determining a solution of an optimization function expressed by the sum of two terms. Although it is useful even when the optimization function is ill-conditioned, it is not possible to find a solution for an optimization problem under multiple structures where there are two structures postulated in the solution. The methods of NPL 2 to 4 can deal with optimization problems under multiple structures. One problem, however, is that, when the function to be minimized is ill-conditioned, it takes a long time to obtain a solution.

In view of the problems described above, an object of the present invention is to provide a technique whereby a solution of an optimization problem under multiple structures can be obtained at high speed even when a function to be minimized is ill-conditioned.

### Means for Solving the Problem

To solve the problems described above, one aspect of the present invention relates to a computing device that computes an optimal solution of an optimization function f+g+h represented by a sum of three functions f, g, and h, including: a first computing unit that computes a proximal point of a function F+h representing the optimization function f+g+h, the function F+h being a sum of a function F=f+g represented by a sum of two functions f and g and a function h; a second computing unit that computes an approximate proximal point of the function F; and a convergence determination unit that determines whether or not a predetermined termination condition is satisfied based on a proximal point computed by the first computing unit and an approximate proximal point computed by the second computing unit, and causing the first computing unit and the second computing unit to repeatedly compute the proximal point and the approximate proximal point until the predetermined termination condition is satisfied.

### Effects of the Invention

According to the present invention, a solution of an optimization problem under multiple structures can be obtained at high speed even when a function to be minimized is ill-conditioned.

### BRIEF DESCRIPTION OF DRAWINGS

FIG. 1 is a block diagram illustrating a functional configuration of a computing device according to one embodiment.

FIG. 2 is a flowchart illustrating an optimal solution computing process according to one embodiment.

FIG. 3 is a flowchart illustrating a process of a primal-dual method according to one embodiment.

FIG. 4 is a diagram illustrating a comparison of convergence time between the optimal solution computing process according to one embodiment of the present invention and prior art.

### DESCRIPTION OF EMBODIMENTS

The following embodiment discloses a computing device that calculates an optimal solution of an optimal problem under multiple structures. More particularly, the computing device according to the following embodiment computes an optimal solution of an optimization problem defined by three functions

ƒ: [symbol] ⁿ [symbol] ,g,h: [symbol] ^{d}→ [symbol] ∪{∞} [Formula 1]

and a matrix

A∈ [symbol] ^{n×d} [Formula 2]

where the optimization problem being

$${min}_{x ∈ {ℝ}^{d}} f ( A x ) + g ( x ) + h ( x ) . \qquad [ Formula 3 ]$$

With the computing device according to the following embodiment, an optimal solution can be obtained at high speed even when the function to be minimized f(Ax)+g(x)+h(x) is ill-conditioned.

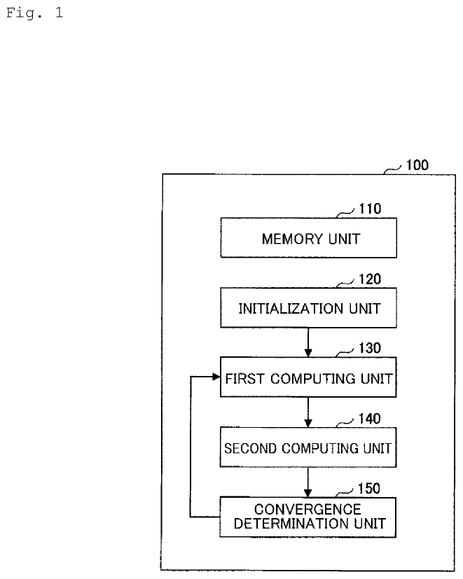

First, the computing device according to one embodiment of the present invention will be described with reference to FIG. 1. FIG. 1 is a block diagram illustrating a functional configuration of a computing device according to one embodiment.

As illustrated in FIG. 1, the computing device 100 includes a memory unit 110, an initialization unit 120, a first computing unit 130, a second computing unit 140, and a convergence determination unit 150.

The memory unit 110 stores parameters that specify a target optimization problem. Specifically, the memory unit 110 stores three functions that configure an optimization function,

f: [symbol] ⁿ→ [symbol] ,g,h: [symbol] ^{d}→ [symbol] ∪{∞} [Formula 4]

a matrix,

A∈ [symbol] ^{n×d} [Formula 5]

and parameters

γ∈ [symbol] _{>0} [Formula 6]

to be used in a computing process to be described later. Here, γ is a positive real number and may be set as suited. For example, γ may be 1 (γ=1). The respective functions, matrix, parameters and others are input from outside in advance and stored in the memory unit 110.

Function f, of the three functions f, g, and h given above is the function to be minimized. Functions g and h are functions that impose constraints and regularization on the function f to be minimized, i.e., functions that represent structures postulated in the solution. The function that is the object of optimization is expressed as follows:

$$\begin{matrix}[ Formula 7 ] & \\ {min}_{x ∈ {ℝ}^{d}} f ( A x ) + g ( x ) + h ( x ) , & ( 1 ) .\end{matrix}$$

The initialization unit 120 sets the value of a first point z₁ of a point sequence {zₜ} (t being an index that represents the number of repetitions) to be used for the computation of a proximal point in the process that follows. z₁ is a real d-dimension vector. The initialization unit 120 sets the value of each element of vector z₁ to a suitable real number. The initialization unit 120 sets the number of repetitions t to 1 (t=1).

The first computing unit 130 computes a proximal point prox_{γh}(zₜ) of zₜ relating to the function h. More specifically, the first computing unit 130 substitutes F(x) for f(Ax)+g(x),

F(x):=f(Ax)+g(x) [Formula 8]

taking Expression (1), which is the function that is the object of minimization, as the sum of two functions F(x) and h(x),

F(x)+h(x) [Formula 9]

obtains a proximal point prox_{γh}(zₜ) by the Douglas-Rachford method, and sets it as xₜ.

The second computing unit 140 computes point uₜ (here, uₜ=2xₜ−zₜ) using the proximal point xₜ determined by the first computing unit 130, and computes an approximate proximal point yₜ of the uₜ relating to the function F(x) above, i.e., point yₜ approximate to the proximal point prox_{γF}(uₜ). For this computation, the second computing unit 140 in this embodiment uses a primal-dual method. The process of the primal-dual method will be described later in detail.

The convergence determination unit 150 computes a next point zₜ₊₁ (here, zₜ₊₁=zₜ+yₜ−xₜ) using xₜ determined by the first computing unit 130, yₜ determined by the second computing unit 140, and the current zₜ, terminates the process if a predetermined termination condition is satisfied, and outputs the solution xₜ. If the predetermined termination condition is not satisfied, the convergence determination unit 150 increments t by 1 to cause the first computing unit 130 to repeat the computation of the proximal point. For example, a predefined evaluation function representing the accuracy of the current solution xₜ having reached a preset threshold, or the number of repetitions t having reached a preset threshold may be used as the termination condition. An evaluation function reaching a preset threshold may include, for example, an amount of decrease in training errors f(xₜ₋₁)−f(xₜ) being smaller than a predefined threshold, an amount of decrease in validation errors being smaller than a predefined threshold, and the minimum value of the validation error calculated from the solutions x₁, . . . , xₜ being not renewed for a period of a preset number of iterations.

The computing device 100 may typically be realized by a computing device such as a server, and may be made up of drive devices mutually connected via a bus B, an auxiliary memory device, a memory device, a processor, an interface device, and a communication device, for example. Various computer programs including the programs that implement various functions and processes in the computing device 100 may be provided by a recording medium such as a CD-ROM (Compact Disk-Read Only Memory), DVD (Digital Versatile Disk), a flash memory, and the like. The program may be installed from the recording medium to the auxiliary memory device via the drive device when the recording medium storing the program therein is set in the drive device. Note, the program need not necessarily be installed from a recording medium, and may be downloaded from any external device via a network or the like. The auxiliary memory device stores the installed program, as well as necessary files and data. Upon receiving a program launch instruction, the memory device reads out the program and data from the auxiliary memory device and stores the same. The processor executes the various functions and processes of the computing device 100 described above in accordance with the program stored in the memory device and various data such as parameters necessary for executing the program. The interface device is used as a communication interface for connection with a network or an external device. The communication device executes various communication processes for communications with a network such as Internet.

It should be noted that the computing device 100 is not limited to the hardware structure described above and may be implemented by any other suitable hardware configurations.

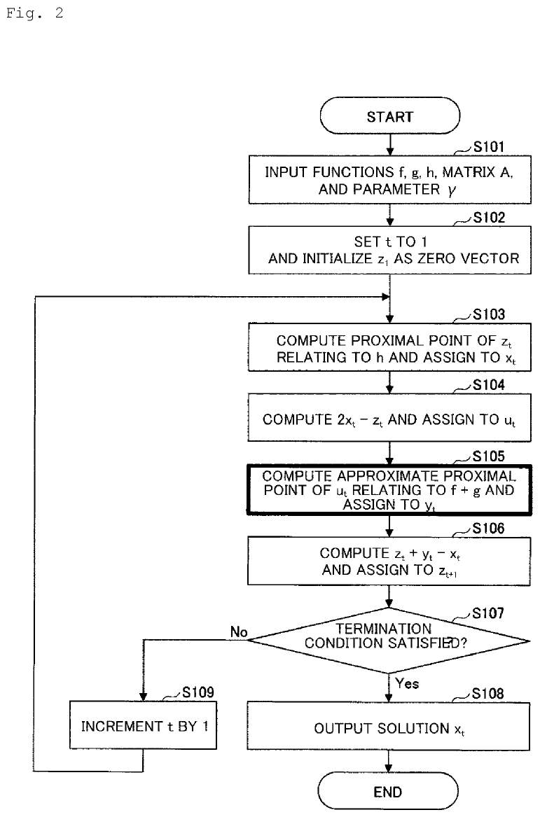

Next, the optimal solution computing process according to one embodiment of the present invention will be described with reference to FIG. 2. FIG. 2 is a flowchart illustrating the optimal solution computing process according to one embodiment.

At step S101, the memory unit 110 stores the three functions f, g, and h, matrix A, and parameter γ that configure the optimization function input to the computing device 100.

At step S102, the initialization unit 120 sets the index t of the point sequence {zₜ} to 1 (t=1), and initializes z₁ as zero vector.

At step S103, the first computing unit 130 computes the proximal point prox_{γh}(zₜ) of zₜ relating to the function h by the Douglas-Rachford method, and assigns it to xₜ.

At step S104, the second computing unit 140 computes the approximate proximal point of uₜ relating to f+g that is the sum of the functions f and g by the primal-dual method, and assigns it to yₜ.

At step S105, the convergence determination unit 150 computes zₜ+yₜ−xₜ and assigns the value to zₜ₊₁.

At step S106, the convergence determination unit 150 determines whether or not a predetermined termination condition is satisfied, and if the termination condition is satisfied (S106: Yes), the process goes to step S107, where the computing device 100 outputs the solution xₜ. On the other hand, if the termination condition is not satisfied (S106: No), the convergence determination unit 150 increments the index t by 1, and the process returns to step S103 and steps S103 to S106 described above are repeated.

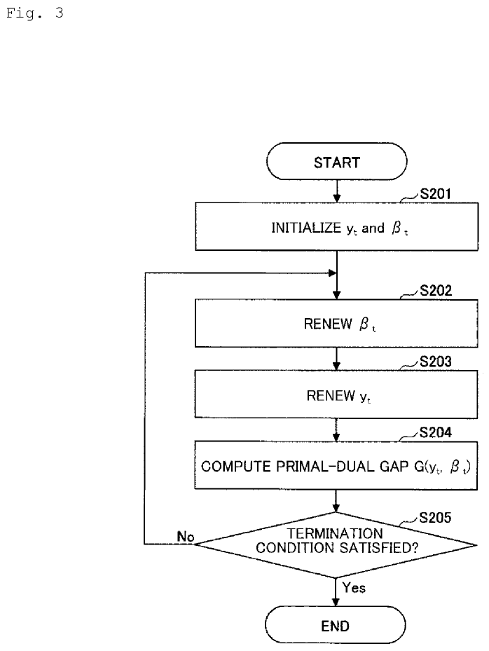

Next, the process of the primal-dual method at step S104 according to one embodiment of the present invention will be described in detail with reference to FIG. 3. FIG. 3 is a flowchart illustrating a process of a primal-dual method according to one embodiment of the present invention. Namely, FIG. 3 illustrates the details of step S103 in which the second computing unit 140 computes the approximate proximal point yₜ of uₜ (here, uₜ=2xₜ−zₜ) relating to the function F (F=f+g) by the primal-dual method. In the primal-dual method according to this embodiment, a dual solution βₜ is computed at the same time along with the approximate proximal point yₜ.

As illustrated in FIG. 3, at step S201, the second computing unit 140 initializes yₜ and βₜ. Specifically, the second computing unit 140 initializes

βₜ←(1−θ)βₜ₋₁+θ∇f(Ayₜ₋₁) [Formula 10]

βₜ using yₜ₋₁ and βₜ₋₁, and

yₜ←prox_{γg}(uₜ−γA^{T}βₜ) [Formula 11]

initializes yₜ using the initialized βₜ. Here, ∇f represents the gradient of the function f, and θ∈(0, 1) represents parameters defined by backtracking.

At step S202, the second computing unit 140 renews βₜ by:

βₜ←(1−θ)βₜ+θ∇f(Ayₜ). [Formula 12]

At step S203, the second computing unit 140 renews yₜ by:

yₜ←prox_{γg}(uₜ−γA^{T}βₜ) [Formula 13]

At step S204, the second computing unit 140 computes a primal-dual gap G(yₜ, βₜ) by:

G(y,β)=f(Ay)+f*(β)−<Ay,β>. [Formula 14]

Here, f* represents a convex conjugate function of the function f, and the symbol <φ,⋅> represents a standard inner product in the Euclidean space.

At step S205, the second computing unit 140 terminates the process if the current (yₜ, βₜ) satisfies the following termination condition based on the primal-dual gap (S205: Yes),

$$G ( {y}_{t} , {β}_{t} ) \leq \frac{1}{4 γ} {‖ {x}_{t} - {y}_{t} ‖}^{2} \qquad [ Formula 15 ]$$

and gives the current yₜ to the convergence determination unit 150. On the other hand, if the condition is not satisfied (S205: No), the second computing unit 140 increments the index t by 1, and the process returns to the step S202 of renewing βₜ. This way, the second computing unit 140 renews yₜ and βₜ repeatedly until the predetermined termination condition is satisfied, i.e., until the primal-dual gap becomes equal to or lower than a preset error.

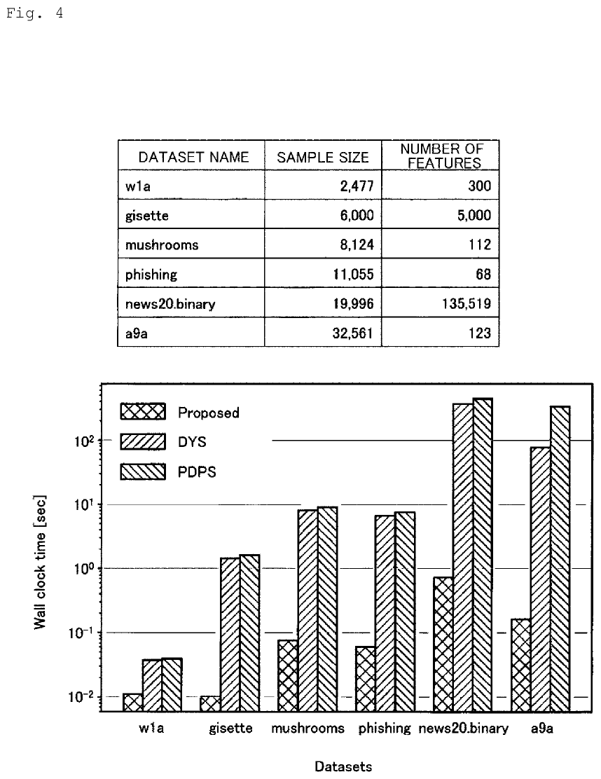

Next, the results of numerical experiments according to the present invention and prior art will be described with reference to FIG. 4. FIG. 4 is a diagram illustrating a comparison of convergence time between the optimal solution computing process according to one embodiment of the present invention and the prior art.

An optimization problem of a kernel support vector machine was solved by various methods using six real datasets shown in FIG. 4. The Davis-Yin method (DYS) shown by NPL 4, and the primal-dual proximal splitting (PDPS) methods shown by NPL 2 and 3 were used as the prior art.

FIG. 4 compares the time until each method converged, wherein it was determined to have converged when a solution was obtained with an error of 10⁻¹ or less relative to an optimal solution. The Gaussian kernel was used as the kernel function, and Nystrom approximation was used for simplifying the computation. The figure indicates that the present invention is about 100 times faster than the prior art in most cases.

While one embodiment of the present invention has been described in detail above, the present invention is not limited to the specific embodiment described above and various modifications and alterations are possible within the scope of the subject matter of the present invention set forth in the claims.

### REFERENCE SIGNS LIST

100 Computing device
110 Memory unit
120 Initialization unit
130 First computing unit
140 Second computing unit
150 Convergence determination unit

1.-8. (canceled)

9. A computer-implemented method for determining aspects of an optimization function, the method comprising:
receiving a first function, a second function, and a third function;
generating a fourth function, wherein the fourth function includes a combination of the received first function and the received second function;
generating a fifth function, wherein is the fifth function includes a combination of the received third function and the generated fourth function;
determining, using the fifth function as an optimization function, a proximal point of the fifth function;
determining an approximate proximal point of the fourth function;
determining, based on a predetermined termination condition and iterative determining of the proximal point and the approximate proximal point, an answer to the optimization function, wherein the predetermined termination condition is based on a difference between the iteratively determined proximal point and the iteratively determined approximate proximal point; and
providing the determined answer as an optimization solution of the received first function, the received second function, and the received third function.

10. The computer-implemented method of claim 9, the method further comprising:
determining the proximal point of the fifth function using Douglas-Rachford method for minimizing a sum of two terms.

11. The computer-implemented method of claim 9, the method further comprising:
determining the approximate proximal point of the fourth function using a primal-dual method.

12. The computer-implemented method of claim 9, the method further comprising:
determining the approximate proximal point of the fourth function using a dual solution.

13. The computer-implemented method of claim 9, wherein the predetermined termination condition includes a predetermined threshold using a predetermined evaluation function, and wherein the predetermined evaluation function determines a level of accuracy of the iteratively determined proximal point.

14. The computer-implemented method of claim 9, wherein the predetermined termination condition includes a number of iterations for iteratively determining the proximal point and the approximate proximal point.

15. The computer-implemented method of claim 9, wherein the determined answer as an optimization solution relates to minimizing a combined output of the first function, the second function, and the third function, and wherein the fifth function is ill-conditioned.

16. A system for determining aspects of an optimization function, the system comprises:
a processor; and
a memory storing computer-executable instructions that when executed by the processor cause the system to:
receive a first function, a second function, and a third function;
generate a fourth function, wherein the fourth function includes a combination of the received first function and the received second function;
generate a fifth function, wherein is the fifth function includes a combination of the received third function and the generated fourth function;
determine, using the fifth function as an optimization function, a proximal point of the fifth function;
determine an approximate proximal point of the fourth function;
determine, based on a predetermined termination condition and iterative determining of the proximal point and the approximate proximal point, an answer to the optimization function, wherein the predetermined termination condition is based on a difference between the iteratively determined proximal point and the iteratively determined approximate proximal point; and
provide the determined answer as an optimization solution of the received first function, the received second function, and the received third function.

17. The system of claim 16, the computer-executable instructions when executed further causing the system to:
determine the proximal point of the fifth function using Douglas-Rachford method for minimizing a sum of two terms.

18. The system of claim 16, the computer-executable instructions when executed further causing the system to:
determine the approximate proximal point of the fourth function using a primal-dual method.

19. The system of claim 16, the computer-executable instructions when executed further causing the system to:
determining the approximate proximal point of the fourth function using a dual solution.

20. The system of claim 16, wherein the predetermined termination condition includes a predetermined threshold using a predetermined evaluation function, and wherein the predetermined evaluation function determines a level of accuracy of the iteratively determined proximal point.

21. The system of claim 16, wherein the predetermined termination condition includes a number of iterations for iteratively determining the proximal point and the approximate proximal point.

22. The system of claim 16, wherein the determined answer as an optimization solution relates to minimizing a combined output of the first function, the second function, and the third function, and wherein the fifth function is ill-conditioned.

23. A computer-readable non-transitory recording medium storing computer-executable instructions that when executed by a processor cause a computer system to:
receive a first function, a second function, and a third function;
generate a fourth function, wherein the fourth function includes a combination of the received first function and the received second function;
generate a fifth function, wherein is the fifth function includes a combination of the received third function and the generated fourth function;
determine, using the fifth function as an optimization function, a proximal point of the fifth function;
determine an approximate proximal point of the fourth function;
determine, based on a predetermined termination condition and iterative determining of the proximal point and the approximate proximal point, an answer to the optimization function, wherein the predetermined termination condition is based on a difference between the iteratively determined proximal point and the iteratively determined approximate proximal point; and
provide the determined answer as an optimization solution of the received first function, the received second function, and the received third function.

24. The computer-readable non-transitory recording medium of claim 23, the computer-executable instructions when executed further causing the system to:
determine the proximal point of the fifth function using Douglas-Rachford method for minimizing a sum of two terms.

25. The computer-readable non-transitory recording medium of claim 23, the computer-executable instructions when executed further causing the system to:
determine the approximate proximal point of the fourth function using a primal-dual method.

26. The computer-readable non-transitory recording medium of claim 23, the computer-executable instructions when executed further causing the system to:
determining the approximate proximal point of the fourth function using a dual solution.

27. The computer-readable non-transitory recording medium of claim 23, wherein the predetermined termination condition includes a predetermined threshold using a predetermined evaluation function, and wherein the predetermined evaluation function determines a level of accuracy of the iteratively determined proximal point.

28. The computer-readable non-transitory recording medium of claim 23, wherein the predetermined termination condition includes a number of iterations for iteratively determining the proximal point and the approximate proximal point, wherein the determined answer as an optimization solution relates to minimizing a combined output of the first function, the second function, and the third function, and wherein the fifth function is ill-conditioned.
